(19) United States
(12) Patent Application Publication
(10) Pub. No.: US 2012/0066759 A1
(43) Pub. Date: Mar. 15, 2012

(54) SYSTEM AND METHOD FOR PROVIDING ENDPOINT MANAGEMENT FOR SECURITY THREATS IN A NETWORK ENVIRONMENT

(75) Inventors: Yan Chen, Boonton Township, NJ (US); Philip J.S. Gladstone, Carlisle, MA (US)

(73) Assignee: Cisco Technology, Inc.

(21) Appl. No.: 12/879,925

(22) Filed: Sep. 10, 2010

(51) Int. Cl. G06F 21/00

(52) U.S. Cl. 726/15; 726/24

(57) ABSTRACT

An example method is provided and includes monitoring activity within an endpoint, and identifying a source associated with a particular data segment received by the endpoint. The method also includes monitoring an antivirus mechanism within the endpoint. The antivirus mechanism is configured to identify the particular data segment as being associated with malware. The source associated with the particular data segment can be communicated to any suitable next destination.

### TECHNICAL FIELD

This disclosure relates in general to the field of network security and, more particularly, to providing endpoint management for security threats in a network environment.

### BACKGROUND

Antivirus software can be used to prevent, detect, and remove malware from computers (e.g., computer viruses, worms, phishing issues, Trojan horses, denial of service (DoS) mechanisms, etc.). Such antivirus programs may also prevent and remove adware, spyware, and other forms of malware. Any number of security deployment strategies can be used to address these problematic malware forms. For example, signature-based detection can be used to search for known malicious patterns in executable code. However, it is possible for a user to be infected with new malware for which no signature currently exists. Certain antivirus software can also predict the behavior of a file if opened/run by a given endpoint. Although these strategies have proven viable, they are still flawed in many ways. One important issue associated with all of these security activities is lag time, which can be problematic. As a general proposition, protecting a given endpoint from security threats, while consuming minimal resources and while maintaining system performance, presents a significant challenge to equipment vendors, network operators, and system designers alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for providing endpoint management for security threats in a network environment in accordance with one embodiment of the present disclosure;

FIG. 2 is a simplified block diagram illustrating additional details related to an example infrastructure of the communication system in accordance with one embodiment;

FIG. 3 is a simplified block diagram illustrating additional details related to an example infrastructure of the communication system in accordance with one embodiment;

FIG. 4 is a simplified flowchart illustrating details related to certain components of the communication system in accordance with one embodiment; and

FIG. 5 is a simplified flowchart illustrating details related to certain components of the communication system in accordance with one embodiment.

### DETAILED DESCRIPTION OF EXAMPLE EMBODIMENTS

### Overview

An example method is provided and includes monitoring activity within an endpoint (or simply monitoring suspicious behaviors of the endpoint), and identifying a source associated with a particular data segment received by the endpoint. The method also includes monitoring an antivirus mechanism within the endpoint. The antivirus mechanism can be configured to identify the particular data segment as being associated with malware. The source (and the signature) associated with the particular data segment can be communicated to any suitable next destination. For example, the architecture described below can effectively identify the source and signature of the malware (and/or the container/compressed file that contains the malware).

In more specific embodiments, the source (and the signature) associated with the particular data segment is communicated to a network element that updates a reputational metric associated with the source. In addition, the source associated with the particular data segment can be used to change filtering activities associated with security protocols for the endpoint. The particular data segment can be associated with a compressed file, a packaged file, a zip file, a malicious data file downloaded from a server, an e-mail received by the endpoint, or the data segment can be associated with a removable device (e.g., a universal serial bus key, a disc, an external hard drive, etc.) that interfaced with the endpoint.

### Example Embodiments

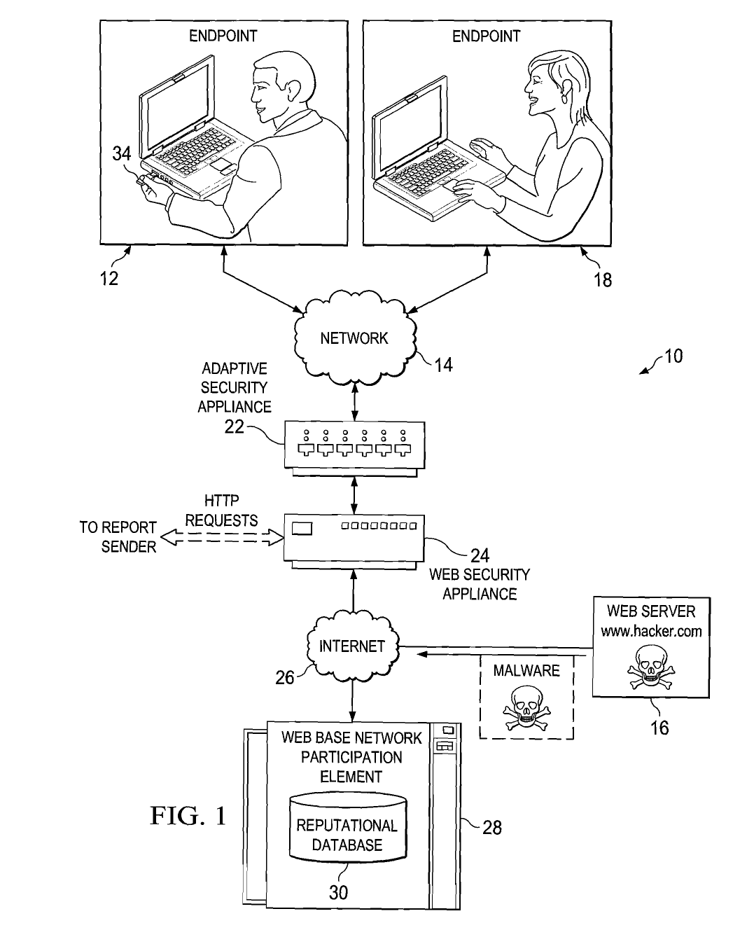

Turning to FIG. 1, FIG. 1 is a simplified block diagram of a communication system 10 for providing endpoint threat telemetry to improve filtering effectiveness in accordance with one example embodiment of the present disclosure. FIG. 1 includes an endpoint 12 and an endpoint 18: both of which have a network connection to a network 14. A web server 16 is also connected to an Internet 26, where this particular web server 16 is associated with a uniform resource locator (URL) www.hacker.com. Web server 16 includes malicious software (e.g., in the form of malware files, as is illustrated). An adaptive security appliance (ASA) 22 is coupled to a web security appliance (WSA) 24, where hypertext transfer protocol (HTTP) requests may be generated and sent to a report sender element, as further detailed below. In addition, WSA 24 may be coupled to web base network participation (WBNP) element 28, which further includes a reputational database 30 in this particular example.

In one particular instance, WBNP element 28 can be used in order to distribute reputational data to endpoints 12 and 18 (or to other entities that subscribe to this type of reputational data feed). WSA 24 can be used to provision appropriate filtering mechanisms for endpoints 12 and 18 in certain implementations of communication system 10. In other instances, filtering can occur in a web cloud, or in any other suitable location, device, network appliance, etc. Note that ASA 22 is particular to a virtual private network (VPN) configuration, which can allow a given end user to securely dial into a given enterprise and be protected from a security threat.

Communication system 10 may include a configuration capable of transmission control protocol/internet protocol (TCP/IP) communications for the transmission and/or reception of packets in a network. Communication system 10 may also operate in conjunction with a user datagram protocol/IP (UDP/IP) or any other suitable protocol where appropriate and based on particular needs. Communication system 10 may also readily operate in conjunction with various types of VPN protocols, as discussed below.

For purposes of illustrating certain example techniques of communication system 10, it is important to understand the security issues applicable to many endpoints. The following foundational information may be viewed as a basis from which the present disclosure may be properly explained. Antivirus solutions have become less effective because they are signature based, which requires an antivirus vendor to receive the problematic malware before generating the appropriate signature. Hence, there is a lag time in the malware appearing in a network, and a security appliance incorporating the malware into its preventative security protocols. This lag time (i.e., between receiving malicious content and effectively addressing filtering mechanisms to account for this latest content) can be several days, or even several months.

To address some of these deficiencies, reputational databases have emerged. As part of this security protocol, there is a general understanding of the place from which malware emanates. The associated filtering systems do not record these events immediately and, instead, delay incorporating this information into their structures for long time periods. Note that computers that use security service infrastructure, which is based on filtering in the cloud, have much less chance of getting web-based attacks (e.g., viruses, phishing, spyware, etc.) but they are still not immune from breaches in security. Currently, if endpoints are infected by malicious content, there is no effective way for an associated system to determine if and/or how the malicious content breached the security defenses of the system. Moreover, endpoints have no effective and/or automated mechanism for determining the origin of the malicious content. This malware could have been transferred through the filtering system (in which case it was a failure of the filtering system) or it could have come via some other route (such as from an infected USB key, an e-mail, a zip file, etc.).

In accordance with certain embodiments of the present disclosure, communication system 10 can address many of these issues (and others) by providing an optimal endpoint management architecture. In certain examples, communication system 10 can be configured to use real-time data from endpoints to improve the effectiveness of filtering services. In addition, the automated identification of malicious content origins can be achieved by aggregating intercepted operations and, in some cases, by tracing application activities. This can further include retaining the activities in a history repository and, subsequently, searching these repositories at appropriate times for the purpose of tracing the origin of the malicious content.

In certain cases, the telemetry report can be triggered by a notification of a threat detection, which can be communicated by an antivirus mechanism. The term ‘antivirus mechanism’ is inclusive of any personal computing antivirus software, enterprise antivirus software, mobile computing antivirus software, VPN antivirus software, systems that detect undesirable data segments generally (not necessarily limited to viruses), or any other suitable security hardware and/or software that may be provisioned for a given endpoint. In addition, triggering of the telemetry report can be done via a notification of the detection of suspicious behaviors on the endpoints and/or from a security gateway. The telemetry data itself can be sent directly from the endpoints. Note that in contrast to systems that do not offer telemetry activities, communication system 10 can offer real-time feedback from the endpoints. This can significantly improve the effectiveness of the security service infrastructure because of the resultant improvements to the filtering behaviors.

In operation of one example scenario, a given end user may inadvertently download a malware file from web server 16 to endpoint 12. Once that file propagates to endpoint 12, it may be copied or moved to various internal locations of endpoint 12. Endpoint 12 is configured to intelligently track the malicious code as it moves about the endpoint system. At some juncture, an antivirus scan may be executed on endpoint 12 (e.g., weekly, daily, based on a certain event, based on a user initiative, etc.) such that the malicious file is indeed detected. The intelligent tracking mechanism of endpoint 12 can be leveraged in order to identify the exact source from which the malicious file originated. Hence, in more general terms, the architecture can monitor endpoint activity (e.g., downloads, processing, function calls, library access, any type of file manipulation, any type of security setting manipulation, etc.) and intelligently track the origins of the data segments associated with this activity. More specifically, the data segments could relate to URLs, data files, zip files, programs, malicious code, or any other type of data segment that may be associated with malware (e.g., a virus, a Trojan, a worm, a phishing attack, a malicious file, or any other type of unwanted security breach for the endpoint). It should be noted that the term ‘container file’ refers to any type of compressed file, packaged file, zip file, etc. that may be associated with malware.

In a more generalized scenario, any type of centralized antivirus monitoring mechanism within communication system 10 can (on receipt of an antivirus detection message) cause the browser history log to be retrieved from the endpoint, search the browser history log (on the central system) to find the reference to the antivirus detected file, and discover the source URL. Subsequently, the source URL can be communicated to any other system, location, destination, etc.

In certain instances, the malware file could be tracked to a universal serial bus (USB) key 34, to an e-mail received from endpoint 18, from an internal Intranet link, or from any other suitable location. The malware could cause suspicious behavior (i.e., any type of computing anomaly), or metastasize as part of a virus, a security breach, etc. Further, a malicious data segment may be part of a zip file from which the particular malicious data sprung while in a different format. Endpoint 12 can effectively track file movement (e.g., zip file expansion) as part of its history logging. In one sense, endpoint 12 can generate a logical nexus from the zipped file to the previous file format, and then from that format to the website at which the file was originally downloaded. The culprit website can be identified and sent to WBNP element 28 such that reputational data can be updated (or at least aggregated with other similar messages) in order to eventually affect reputational issues in the network.

The identification information may be gleaned from appropriate logging operations, as detailed herein. The resultant data that is indicative of the source of the malicious file can be sent to any suitable aggregation point. For example, there could be a global server that is configured to receive such information. The aggregated telemetry information can be used to empower the aggregation point (which may be receiving a number of these messages) to modify its filtering activities (e.g., policy decisions, network security protocols, firewall provisioning, etc.). In other instances, such telemetry information can be used to thwart future malicious files propagating to subscribing endpoints. In yet other instances, such information can be used to change reputational metrics associated with particular entities (e.g., specific IP addresses associated with web servers, network appliances, individual users, etc.). This would allow other endpoints to benefit from the results of the modified filtering. In other cases, where this malicious file source is USB key 34, a network administrator could more closely monitor USB access for his assigned personnel, or disable certain USB privileges for certain machines, end users, etc.

Additionally, the proffered architecture can provide source feedback from infected endpoints (automatically in real-time) to the security service infrastructure. This can enhance the filtering activities being performed by the security service infrastructure. With the telemetry data directly from the endpoints, the security service infrastructure can strengthen the filtering algorithm by analyzing and correlating the data feeds in real-time from a potentially vast number of endpoints.

In terms of the chronology of events, the architecture can perform several steps in order to accomplish the intelligent management of security threats for endpoints operating in a network environment. The first step is to identify the origin of any content received by the endpoint, where this is performed automatically at the time when the file with the malicious content has been created and/or written. The system is configured to identify system/user application program interface (API) functions related to interested operations (e.g., URL processing, file copy, file rename, file compression, file creation, file open for reading or writing, initiate or accept network connection, adding entries to a browser history log, and/or any other operations leading to discovering the origin of the contents received by the endpoint).

The next activity is to impose interceptors on the identified functions, which can intercept the parameter values of the functions when they are called by various application processes. The operations intercepted can be analyzed and, subsequently, aggregated into process activities (e.g., download file, copy file, rename file, uncompress file, etc.) based on the type of operations and/or the patterns that the operations performed. Depending on the type of activities, the immediate source of the file can be identified by examining the parameters passed in the corresponding functions.

In a second step, the history of the process activities and the immediate source of the file (from the previous operations) can be maintained. The process activities and the immediate source of the file can be kept in a designated activity history repository. (Note that the broad term ‘source’ as used herein in this Specification is meant to include any information associated with the origin, location, or device at which a particular data segment was retrieved, or at which a particular processing activity occurred). The activity history repository can be one or more designated log files, database, and/or a designated extended attribute (or stream) of the file. The sensitive information in the history repository (e.g., URLs) can be selectively encrypted or hashed irreversibly for data integrity, privacy, and security. The activity history repository can be compressed dynamically for storage conservation. The size of the activity history repository can be limited by the specified maximum repository size or by the specified maximum retaining time in particular implementations.

In a third step, monitoring occurs in order to detect malicious content on the endpoint, and/or to detect suspicious behavior of the endpoint caused by the malicious content. The detection of malicious content can be achieved by monitoring the threat detection event or the log record of the antivirus software running on the endpoint, or by monitoring the file deletion operations of the antivirus software process. The detection of malicious content can also be done by the user manually, upon the recognition of the malicious content on the endpoint. The detection of suspicious behavior caused by the malicious content can be achieved by observing the dangerous or known unsecure activities (e.g., the first time execution of a previously downloaded executable file, the first time loading of a previously downloaded library file, etc.) on the endpoint. The detection of suspicious behavior caused by the malicious content can also be achieved by observing the endpoint making a network connection to a known malicious site by the security gateway of the infrastructure.

The fourth step is to generate a telemetry report about the origin of the malicious or suspicious file (i.e., as identified by the third step above). Any of the elements in the third step can be used as a trigger to generate the telemetry report. In case multiple activities have been performed for the contents of the file (e.g., a file is extracted from a compressed file, which was downloaded from a URL), the content origin of the file can be determined by back tracing the activities performed on the contents of the file (as found in the activity history repository). In the case where the trigger is from the security gateway, the endpoint can first identify which application triggered the event, and then find the origin of the application executable file.

The fifth step is to deliver the telemetry report to the telemetry receiver of the security service infrastructure. The actual report can contain any number of parameters, some of which may include: file name, file origin (URL, URL referral, removable device type, etc.), file signature, file size, time stamp, application which created the file, dynamic link library (DLL) that created the file, the threat name, the endpoint postures, the endpoint state, etc. The telemetry report can be delivered through a secure channel with privacy protection enforced. Additionally, the report can be encrypted for data security, integrity, privacy (i.e., to prevent data leakage, loss, or the report being altered).

The sixth step is to utilize the telemetry data by the security service infrastructure. For example, the telemetry data can be used to strengthen the filtering algorithm by analyzing and correlating the data feeds in real-time from multiple endpoints. The telemetry data can also be used to improve the accuracy of the reputational database by utilizing the malicious content origin information in a timely manner. The malware origin and/or the signature of the malware detected by the antivirus software on the endpoint can account for missing malware information in the malware database of the security service infrastructure. The telemetry data can be used to assess the effectiveness of the security service infrastructure and, further, find vulnerabilities in the security protocols. In certain cases, the telemetry data can also be used as an incident reporting facility. Semantically, local security administrators can use these telemetry reports to determine the sources of malware in their organization. This can lead to policy changes (such as restricting the use of USB keys) to reduce the amount of malware reaching their company endpoints.

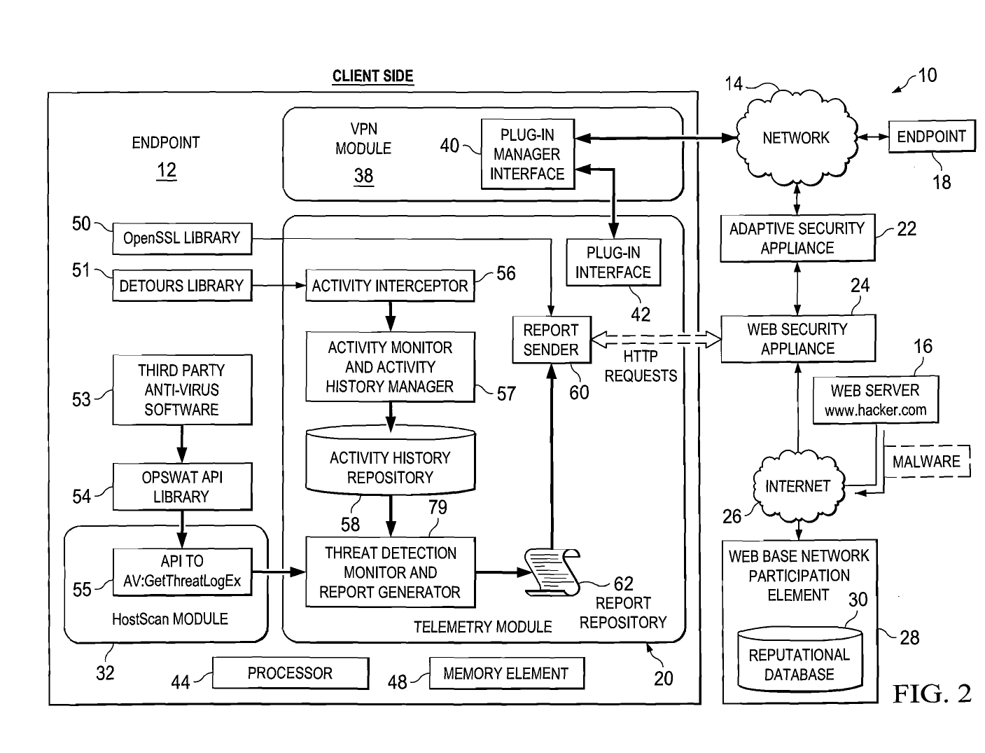

Turning to FIG. 2, FIG. 2 is a simplified block diagram illustrating additional details related to an example infrastructure of communication system 10 in accordance with one embodiment. As illustrated in FIG. 2, each of the endpoints can be provisioned with a respective telemetry module, HostScan module, processor, and a respective memory element. Each of the endpoints can also include suitable interfaces for receiving and/or transmitting data to various network elements.

More specifically, FIG. 2 depicts details associated with a client side and a server side of the proffered architecture. It is imperative to note that this illustrated architecture is merely representative of one of the many possibilities that could be used to achieve the teachings of the present disclosure. In this particular example of FIG. 2, endpoint 12 includes a VPN module 38 (that further includes a plug-in manager interface 40 interacting with a counterpart plug-in interface 42), which has a network connection to network 14. Endpoint 12 also includes an OpenSSL library 50, a detours library 51, a third-party antivirus software 53, an OPSWAT API library 54, and a HostScan module 32, which includes an API to antivirus (AV): GetThreatLogEx 55.

Endpoint 12 may also include a telemetry module 20 that comprises an activity interceptor 56, an activity monitor and activity history manager 57, an activity history repository 58, a threat detection monitor and report generator 79, a report sender 60, and a report repository 62. Additionally, and in more general terms, endpoint 12 is configured with a processor 44 and a memory element 48: both of which can be consolidated in any suitable fashion with the other components of FIG. 2. For purposes of organization, the more general infrastructure of FIGS. 1-2 is detailed immediately below. Subsequently, the more specific implementation details associated with particular modules are discussed.

Endpoints 12 and 18 are representative of devices that can be protected or otherwise managed using various security protocols. In one particular example, endpoints 12 and 18 are representative of personal computers that can be used by individuals for virtually any purpose. It should be noted however that the broad term ‘endpoint’ is inclusive of devices used to initiate a communication, such as any type of computer, a personal digital assistant (PDA), a laptop or electronic notebook, a wireless access point, a residential gateway, a modem, a cellular telephone, an iPhone, an IP phone, an iPad, or any other device, component, element, or object capable of initiating or facilitating voice, audio, video, media, or data exchanges within communication system 10. Endpoints 12 and 18 may also be inclusive of a suitable interface to the human user, such as a microphone, a display, or a keyboard or other terminal equipment. Endpoints 12 and 18 may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, or script data, or any type of source or object code, or any other suitable information in any appropriate format that may be communicated from one point to another. In one particular embodiment, endpoints 12 and 18 support various types of VPN communications.

ASA 22, WSA 24, and WBNP element 28 are network elements that generally manage (or that cooperate with each other in order to manage and/or coordinate) security protocols in a network environment. As used herein in this Specification, the term ‘network element’ is meant to encompass firewalls, virtual network devices, servers, routers, switches, gateways, bridges, loadbalancers, applications, application program interfaces (APIs), EnergyWise infrastructure, Smartgrid devices, inline service nodes, proxies, processors, modules, or any other suitable device, component, element, or object operable to exchange information in a network environment. This network element may include any suitable hardware, software, components, modules, interfaces, or objects that facilitate the operations thereof. This may be inclusive of appropriate algorithms and communication protocols that allow for the effective exchange (reception and/or transmission) of data or information.

Network 14 represents a series of points or nodes of interconnected communication paths for receiving and transmitting packets of information that propagate through communication system 10. Network 14 offers a communicative interface between network elements, devices, endpoints, etc. and may be any local area network (LAN), wireless LAN (WLAN), metropolitan area network (MAN), wide area network (WAN), extranet, Intranet, VPN, or any other appropriate architecture or system that facilitates data propagation in a network environment. Network 14 can foster various types of communications and, further, can be replaced by any suitable network components for facilitating the propagation of data between endpoints and network components. A VPN can offer a secure connection between a given endpoint and any other suitable network node.

Note that endpoints 12 and 18, ASA 22, WSA 24, and WBNP element 28 may share (or coordinate) certain processing operations. Using a similar rationale, their respective memory elements may store, maintain, and/or update data in any number of possible manners. Additionally, because some of these network elements can be readily combined into a single unit, device, or server (or certain aspects of these elements can be provided within each other), some of the illustrated processors may be removed, or otherwise consolidated such that a single processor and/or a single memory location could be responsible for certain activities associated with endpoint management controls. In a general sense, the arrangement depicted in FIG. 2 may be more logical in its representations, whereas a physical architecture may include various permutations/combinations/hybrids of these elements.

In order to achieve its goals in providing real-time feedback to security infrastructure, telemetry module 20 running on a given endpoint as a client agent can have the following basic functionalities. First, it can be configured to identify and record the origin of any content received by the endpoint. In addition, telemetry module 20 can be configured to monitor the arrival of malicious content on the endpoint. Also, telemetry module 20 can be configured to report the incident (along with the origin of the malicious content) to web filtering infrastructure and the endpoint. In one particular provisioning model, telemetry module 20 can be implemented as a plug-in module running on an endpoint loaded and initialized by the VPN service process at the system starting time. The VPN module can provide the session status information and the mobile user security parameters used for communication with WSA 24.

In one example implementation, endpoints 12 and 18 include software (e.g., as part of telemetry module 20) to achieve the intelligent endpoint management operations, as outlined herein in this document. In other embodiments, this feature may be provided externally to any of the aforementioned elements, or included in some other network element (which may be proprietary) to achieve this intended functionality. Alternatively, several elements may include software (or reciprocating software) that can coordinate in order to achieve the operations, as outlined herein. In still other embodiments, any of the devices of the illustrated FIGURES may include any suitable algorithms, hardware, software, components, modules, interfaces, or objects that facilitate these endpoint management operations.

Turning to more specific implementations details, there are four main functional components to telemetry module 20, which may be running as a client agent on an endpoint. First, telemetry module 20 can achieve activity interception. More specifically, system/user operations and API function calls (that can be used to identify the origin of the contents coming into the endpoint) can be intercepted and aggregated into application activities (e.g., the download of a file from a URL by a browser, the copying of a file from a removable device by explorer.exe, etc.). Note that identifying the origin URL is more difficult with applications that do not use Wininet.dll; this includes email applications and file transfers via infrared, Bluetooth, and other mechanisms. However, these items can be effectively back traced to the creator application. For Windows platforms, this can entail imposing hooks on relevant Win32 functions such as the functions in Winnit.dll and Kerel32.dll to intercept the function calls and, ultimately, retrieve the values of parameters passing in and out of the functions.

Second, telemetry module 20 can perform activity monitoring and logging operations. The intercepted application activities can be retained in the activity history repository for a specified period of time and within a specified maximum size limit in order to be used later for contents-origin tracing. The file origin information can be available until the activity history record containing the relevant activities has expired or has been cleaned because of size limitations. The activity history repository can be log files compressed and retained for specified days and/or limited to specified sizes by the repository manager. For security and privacy protection, the URLs can be optionally encrypted by randomly generated symmetric keys.

Third, telemetry module 20 can be configured for threat detection monitoring and report generation. The detection of malicious content notified by the endpoint antivirus software via OPSWAT API can be monitored for triggering the generation of telemetry reports. The reports can contain information about the incident and the relevant activities leading to the incident (e.g., including the origin of the malicious content). The reports can be kept in the report repository directory until it is posted successfully.

Fourth, telemetry module 20 can perform report posting. The telemetry reports generated can be encrypted and sent back through ASA 22 and WSA 24, and then through the existing WBNP 28 telemetry framework to a telemetry backend data center. For connection protocols (e.g., AnyConnect 3.0), the HTTP data with encrypted payload and checksum can be used to ensure data integrity and prevent leakage. WSA 24 can be served as a proxy for HTTP requests.

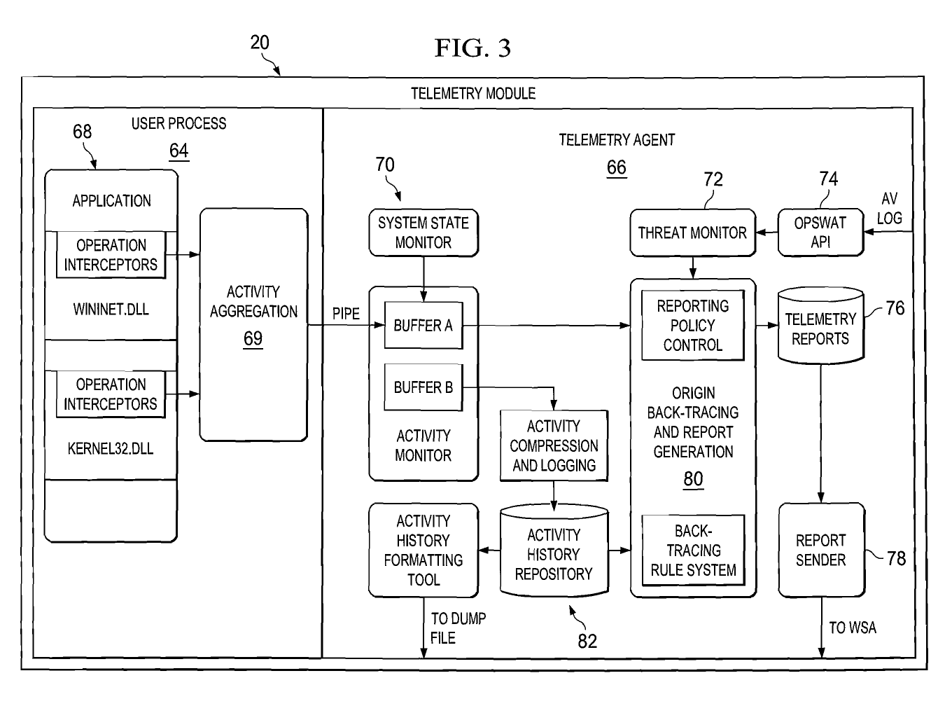

As a plug-in DLL module of VPN service, telemetry module 20 can utilize the following modules to be functional on endpoints running on Windows OS platforms. In one particular example, telemetry module 20 is loaded and initialized by the VPN service process as a plug-in DLL module. VPN module 38 can pass the session state information to a telemetry agent (e.g., telemetry agent 66, as shown in FIG. 3). Otherwise, telemetry agent 66 can run independently (with minimum interactions with its creator) until it is told to shut down, or when the VPN process terminates.

It should be further noted that telemetry agent 66 can be designed to run as an independent service (e.g., such as in a testing environment without VPN module 38 being installed). One reason for electing to use telemetry module 20 as a plug-in (sharing the same process context) is to reduce service administration efforts, and also to facilitate the passing of parameters between VPN module 38 and telemetry module 66. For hash checksum generation and telemetry report encryption, telemetry module 66 can use OpenSSL libraries (libeay32.dll and ssleay32.dll), sharing with other appropriate connection modules. HostScan module 32 can provide an API for telemetry to leverage OPSWAT API library 54 by polling new threat detection records logged by any OPSWAT-compliant antivirus software whenever it detects malware or a virus. HostScan module 32 can also provide APIs for system posture information if needed for the telemetry reports.

For third-party antivirus software, an OPSWAT-compliant antivirus software mechanism can be used to provide the detection of virus and malware notifications in endpoint 12 for telemetry module 20. The antivirus software is typically installed and managed separately. In regards to detours library 51, telemetry module 20 can use various detour packages to implement the hooks into Win32 functions for intercepting the system/user operations and function calls.

In operation, telemetry module 20 can be implemented with a number of major objects. Each object can have its own thread running asynchronously in certain example implementations. Activity interceptor 56 represents a set of hook functions running within user application threads after certain system DLLs used by the application (e.g., as Wininet.dll and Kernel32.dll) are hooked by the telemetry hook DLL at their loading time. Activity interceptor 56 can intercept the operations, aggregate them into activity events, and then send the events through a suitable pathway (e.g., an IPC channel) to an activity-monitoring object.

Activity monitor and activity history manager 57 can interface with activity history repository 58. More specifically, the activity monitor object receives the activity events from the IPC channel, and writes the activity events to a circular buffer. The circular buffer can consist of two sections: a producer section and a consumer section. When the producer section is receiving activity events from the IPC channel, the consumer section can be used for the activity history repository maintenance object to compress the data and write the compressed data to the repository. Before being written to the repository, the URLs in the activity events can be encrypted using the symmetric key that can be randomly generated at the beginning of each VPN session, or that can be generated periodically at a specified time interval.

The activity history repository maintenance thread can compress the activity events data, write the compressed data to an activity history log file, and also monitor the activity history log file to see if these items exceed the size and the retaining date limit. If needed, it can also perform log file rotation or deletion. The threat log monitor object can monitor the threat log file of the third party antivirus software using the Opswat GetThreatLogEx ( ) API via the API of HostScan module 32. If a new threat event arrives, it can trigger the origin back tracing and report generation.

The system state monitor can monitor the change of system states such as VPN session start and termination, telemetry agent start/stop, etc., and then feed the data as activities to the activity monitor. These data can be used to provide the information of the system state when a thread arrives. In addition, a new symmetric key can be generated at VPN session starting time and at telemetry service starting time. The symmetric key can be encrypted using any type of public key mechanism. The versions of the encrypted symmetric key are recorded in the activity history as a system state change event.

The back tracing and report generation can be triggered by the thread log monitor. File origin back trace operations can leverage the activity history data, where these elements report about the incident and relevant activities generated. The subsequent report file can be placed into the report repository. The origins of files can be determined using origin back tracing rules based on activity patterns of various applications. The rules can be controlled by the rule system and, further, added/modified in the future if new activity patterns of applications are encountered. When generating the telemetry report, certain fields of the report can be controlled by the reporting policy specified by the administrator in the configuration profile in order to balance the requirements of privacy and intelligence.

The report sender can monitor the report repository. If a new report is ready to be sent, it can calculate the checksum, encrypt the report file using the protocols specified, and then post the encrypted report by sending an HTTP POST request to the telemetry backend data center via WSA 24. If the post request is successful, the report can be deleted from the repository. If not successful, it can start an error handling procedure.

For the activity history formatting tool, this element can dump the internal activity history data into a human readable text file in case further detailed activity analysis/audition is desired. The service object can manage general housekeeping issues, the interactions associated with VPN module 38 for session status information, service control, and possible user interactions.

Turning to FIG. 3, FIG. 3 is a simplified block diagram illustrating additional details associated with telemetry module 20. It is imperative to note that this depicted architecture is merely representative of one of the many possibilities that could be used to achieve the teachings of the present disclosure. In this particular example, telemetry module 20 includes a user process 68 that includes an activity aggregation 69 and a system state monitor 70, which further includes an interface to an activity monitor that comprises several buffers. FIG. 3 also includes a telemetry agent 66 that includes a threat monitor 72, which interfaces with an origin back tracing and report generation element that includes a reporting policy control and a back tracing rule system. An activity history repository is also provided in FIG. 3, where this element can effectively interface with an activity history formatting tool and with the aforementioned back tracing rule system. Threat monitor 72 may interface with an OPSWAT API 74 and the origin back tracing and report generation element. A repository of telemetry reports 76 can be sent to a report sender 78, which can forward along this information to any suitable next destination (e.g., WSA 24).

Note that the left-hand side of FIG. 3 can be logically thought of as the hooking side intelligence for a given endpoint. For example, the activities and operations of a given endpoint can be effectively hooked or intercepted by a plurality of software modules that are configured to access (i.e., capture, glean, spoof, etc.) such information. For example, one of the operation interceptors can identify particular downloads (e.g., the URL) from a given endpoint. In other cases, the interceptors can monitor sequences in order to identify when something has been downloaded (or otherwise received by the endpoint). This origin and/or source information can be effectively aggregated at activity aggregation 69.

For certain example interactions between the various objects of a given endpoint, the following discussion is proffered. As a plug-in module of VPN service, a telemetry module DLL can reside in the plug-in directory (e.g., % Program Files %\Cisco\Cisco AnyConnect Secure Mobility Client\Plugins\). This can be loaded and initialized by the VPN service process at the service stating time, when the other plug-in modules are loaded. The VPN module can provide the following session state and mobile user security state information to telemetry module 20 when the states have changed:

1) Session Cookie—To generate the VPN session cookie hash, which is the shared secrete among the VPN client, ASA 22, and WSA 24, and is used for building the symmetric key for telemetry report encryption.

2) Encryption cipher used in the VPN session—To determine the encryption level to be used when communicating with WSA 24 for telemetry report posting. There can be two levels (high and low) determined based on the cipher negotiated between ASA 22 and the VPN client.

3) The XML of the mobile user security service status response from WSA 24—To retrieve the telemetry settings from WSA 24.

In regards to the interaction between telemetry module 20 and HostScan module 32, HostScan module 32 can provide a getThreatLog ( ) API for telemetry module 20 to receive the notification when OPSWAT-compliant antivirus software (installed on endpoint 12) detects the malware (e.g., a virus, Trojan, a worm, a malicious file, or any other security breach). Telemetry module 20 can call getThreatLog ( ) with a specified interval (e.g., having a default 60 seconds), where new threat log records are systematically checked.

If appropriate, telemetry module 20 may also call other HostScan APIs for the system posture information for a telemetry report. Telemetry module 20 can rely on HostScan module 32 to provide an up-to-date OPSWAT library. Telemetry module 20 can call the HostScan's “check-for-update” function a first time when a VPN session established, and then every 24 hours after the function is successfully checked. If the VPN session is not turned on at that time, it can be postponed to the next VPN session. If there is a new update, it can download and install the update automatically.

For interactions between telemetry module 20 and WSA 24, if telemetry module 20 is installed at a given endpoint, it can periodically check the telemetry setting parameters in the service status inquiry response from WSA 24 via the VPN agent. For certain software mechanisms (e.g., AnyConnect 3.0), the telemetry feature can be turned on if the customer is using a certain type of security solution with WSA 24, where the <OptIn> parameter is set to “yes.” WSA 24 can be used as a proxy server for telemetry module 20 to post an appropriate telemetry report to WBNP 28. The telemetry setting parameters from WSA 24 can be saved in the registry in the endpoint such that the settings can be used in the case there is no active VPN session.

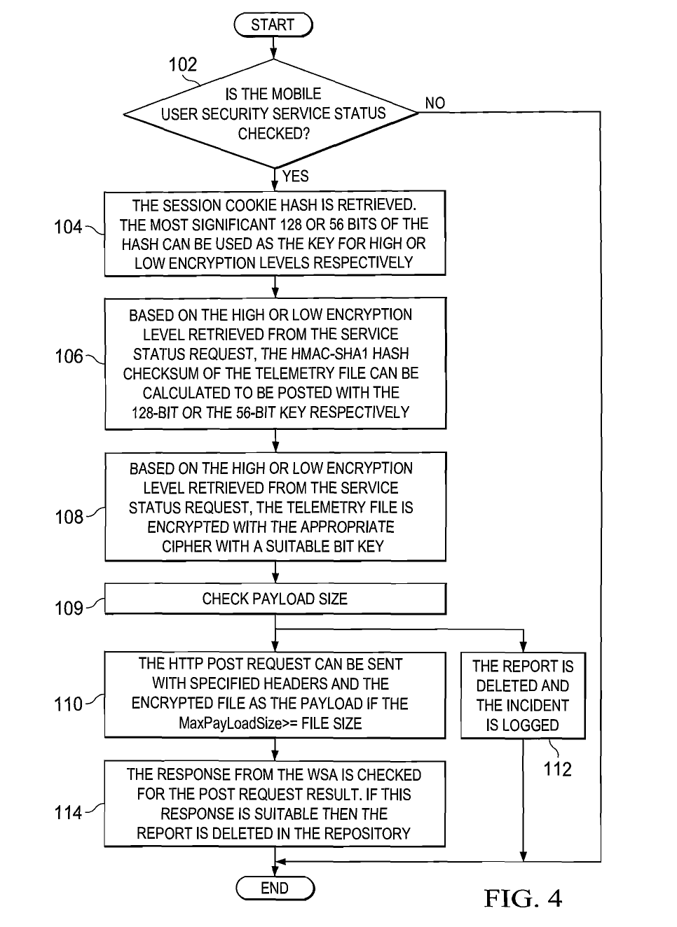

FIG. 4 is a simplified flowchart illustrating one example operation associated with encryption activities and the delivery of a telemetry report. For encryption and hash checksum generation, OpenSSL libraries can be employed. The following steps can be used to execute such operations. In step 102, the mobile user security service status is checked. If the security service is enabled, then the session cookie hash is retrieved at step 104, where this reflects the shared secret between the client endpoint and WSA 24. In one particular instance, the most significant 128 or 56 bits of the hash can be used as the key for high or low encryption levels respectively.

At step 106, based on the high or low encryption level retrieved from the service status request, the HMAC-SHA1 hash checksum of the telemetry file can be calculated to be posted with the 128-bit or the 56-bit key respectively. At step 108, based on the high or low encryption level retrieved from the service status request, the telemetry file is encrypted with the AES-128-CBC cipher with a 128-bit key, or the DES-CBC-CRC cipher with the 56-bit key respectively. At step 109, the payload size is checked in order to determine the appropriate next steps.

At step 110, the HTTP POST request is sent with specified headers and the encrypted file as the payload if the MaxPayloadSize>=file size. Otherwise, the report is deleted and the incident is logged, as shown in step 112. At step 114, the response from WSA 24 is checked for the post request result. If this response is suitable (e.g., if response is “200 OK”) then the report is deleted in the repository. If this does not occur, then appropriate error handling procedures can be executed.

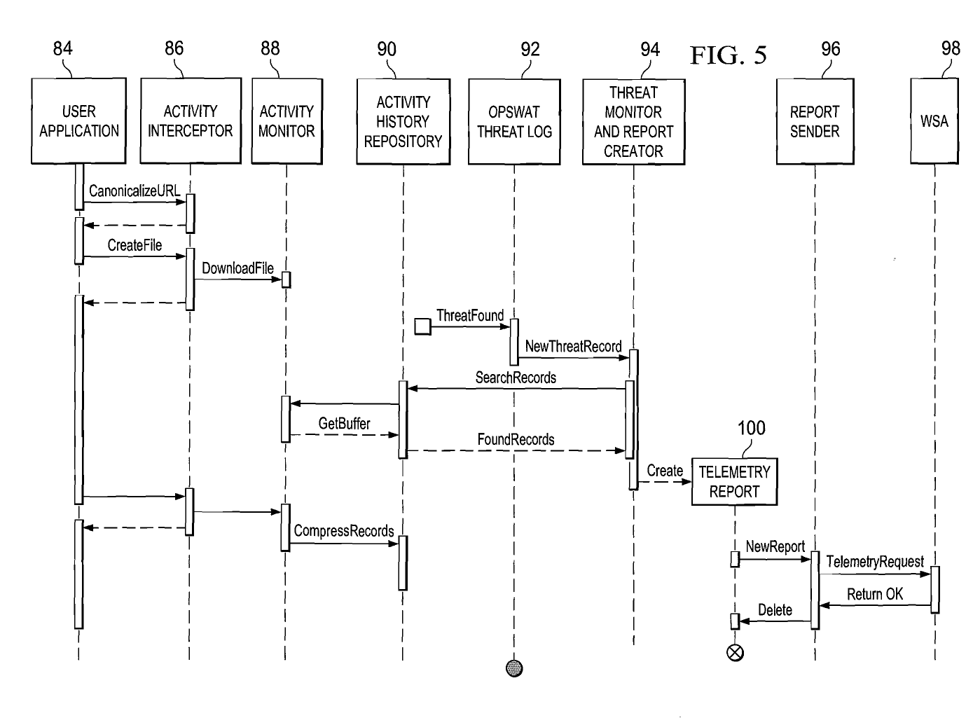

FIG. 5 is a simplified flowchart illustrating one possible example operation associated with communication system 10. More specifically, FIG. 5 depicts a telemetry object sequence diagram that covers interactions among objects and other modules when a report-posting action is triggered by the detection of a downloaded malware file. The interaction of FIG. 5 involves a user application 84, an activity interceptor 86, an activity monitor 88, an activity history repository 90, an OPSWAT threat log 92 (which is simply representative of a third-party AV threat log), a threat monitor and report creator 94, a report sender 96, and a WSA 98. One objective of this particular flow is to generate an appropriate telemetry report 100 to be delivered to WSA 98.

In a first step, user application 84 performs some type of canonical operation for a given URL. A file is subsequently created and sent to activity interceptor 86, while a subsequent file is downloaded. A threat can be found in a subsequent step, and a new threat record may be generated and sent to threat monitor and report creator 94. Records can be suitably searched at this point and buffering objects can be retrieved. Records can be subsequently found such that telemetry report 100 is created. Note that some type of record compression can also occur at this juncture. The new telemetry report 100 can be sent to report sender 96. The telemetry requests can be sent to WSA 98, which can return an appropriate response and the associated report can be archived or deleted.

Note that in certain example implementations, the endpoint security management functions outlined herein may be implemented by logic encoded in one or more tangible media (e.g., embedded logic provided in an application specific integrated circuit (ASIC), digital signal processor (DSP) instructions, software (potentially inclusive of object code and source code) to be executed by a processor, or other similar machine, etc.). In some of these instances, a memory element (as shown in FIG. 2) can store data used for the operations described herein. This includes the memory element being able to store software, logic, code, or processor instructions that can be executed to carry out the activities described in this Specification. A processor can execute any type of instructions associated with the data to achieve the operations detailed herein in this Specification. In one example, the processor (as shown in FIG. 2) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In one example implementation, endpoints 12 and 18 include software in order to achieve the endpoint management functions outlined herein. These activities can be facilitated by telemetry module 20 and/or any other appropriate mechanism. Endpoints 12 and 18 can include memory elements for storing information to be used in achieving the intelligent endpoint management, as outlined herein. Additionally, endpoints 12 and 18 may include a processor that can execute software or an algorithm to perform the endpoint management activities, as discussed in this Specification. These devices may further keep information in any suitable memory element (random access memory (RAM), ROM, EPROM, EEPROM, ASIC, etc.), software, hardware, or in any other suitable component, device, element, or object where appropriate and based on particular needs. Any possible memory items (e.g., database, table, cache, etc.) should be construed as being encompassed within the broad term ‘memory element.’ Similarly, any of the potential processing elements, modules, and machines described in this Specification should be construed as being encompassed within the broad term ‘processor.’

Note that with the examples provided herein, interaction may be described in terms of two or three elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and can accommodate a large number of endpoints, as well as more complicated/sophisticated arrangements and configurations. Accordingly, the examples provided herein should not limit the scope or inhibit the broad teachings of communication system 10 as potentially applied to a myriad of other architectures.

It is also important to note that the steps discussed with reference to FIGS. 1-5 illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular embodiments, it should be understood that various other changes, substitutions, and alterations may be made hereto without departing from the spirit and scope of the present disclosure. For example, although the present disclosure has been described as operating in VPN environments or arrangements, the present disclosure may be used in any environment that could benefit from such telemetry technology. Virtually any configuration that seeks to intelligently control endpoint security can enjoy the benefits of the present disclosure. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A method, comprising:
monitoring activity within an endpoint;
identifying a source associated with a particular data segment received by the endpoint;
monitoring an antivirus mechanism within the endpoint, wherein the antivirus mechanism is configured to identify the particular data segment as being associated with malware; and
communicating the source associated with the particular data segment.

2. The method of claim 1, wherein the source associated with the particular data segment is communicated to a network element that updates a reputational metric associated with the source.

3. The method of claim 1, wherein the source associated with the particular data segment is used to change filtering activities associated with security protocols for the endpoint.

4. The method of claim 1, wherein the particular data segment is associated with a container file.

5. The method of claim 1, wherein the data segment is associated with a data file downloaded from a server.

6. The method of claim 1, wherein the data segment is associated with an e-mail received by the endpoint.

7. The method of claim 1, wherein the data segment is associated with a removable device that interfaced with the endpoint and that caused a computing anomaly.

8. Logic encoded in one or more tangible media that includes code for execution and when executed by a processor operable to perform operations comprising:
monitoring activity within an endpoint;
identifying a source associated with a particular data segment received by the endpoint;
monitoring an antivirus mechanism within the endpoint, wherein the antivirus mechanism is configured to identify the particular data segment as being associated with malware; and
communicating the source associated with the particular data segment.

9. The logic of claim 8, wherein the source associated with the particular data segment is communicated to a network element that updates a reputational metric associated with the source.

10. The logic of claim 8, wherein the source associated with the particular data segment is used to change filtering activities associated with security protocols for the endpoint.

11. The logic of claim 8, wherein the particular data segment is associated with a container file.

12. The logic of claim 8, wherein the data segment is associated with a data file downloaded from a server.

13. The logic of claim 8, wherein the data segment is associated with an e-mail received by the endpoint.

14. The logic of claim 8, wherein the data segment is associated with a removable device that interfaced with the endpoint and that caused a computing anomaly.

15. An apparatus, comprising:
a memory element configured to store code;
a processor operable to execute instructions associated with the code; and
a telemetry module configured to interface with the memory element and the processor such that the apparatus can:
monitor activity within an endpoint;
identify a source associated with a particular data segment received by the endpoint;
monitor an antivirus mechanism within the endpoint, wherein the antivirus mechanism is configured to identify the particular data segment as being associated with malware; and
communicate the source associated with the particular data segment.

16. The apparatus of claim 15, wherein the source associated with the particular data segment is communicated to a network element that updates a reputational metric associated with the source.

17. The apparatus of claim 15, wherein the source associated with the particular data segment is used to change filtering activities associated with security protocols for the endpoint.

18. The apparatus of claim 15, further comprising:
a host scan module coupled to the telemetry module and configured to evaluate threat detection records logged by the antivirus mechanism, which discovers malware incidents.

19. The apparatus of claim 15, wherein a telemetry report is generated in response to a notification of a security threat detected by the antivirus mechanism.

20. The apparatus of claim 15, further comprising:
a virtual private network (VPN) module coupled to the telemetry module and configured to provide session status information to the telemetry module, and to provide security parameters to a security network element.
